(19) United States
(12) Patent Application Publication
(10) Pub. No.: US 2013/0246788 A1
(43) Pub. Date: Sep. 19, 2013

(54) Efficient Delivery of Structured Data Items

(71) Applicants: Itsik Mantin, Shoham (IL); Matan Ninio, Tel Aviv (IL)

(72) Inventors: Itsik Mantin, Shoham (IL); Matan Ninio, Tel Aviv (IL)

(73) Assignee: Cisco Technology, Inc., San Jose, CA (US)

(21) Appl. No.: 13/880,132

(22) PCT Filed: Sep. 22, 2011
(86) PCT No.: PCT/IB2011/054172

§ 371 Date: May 14, 2013

(30) Foreign Application Priority Data
Oct. 26, 2010 (GB) 1018048.7

(51) Int. Cl. H04L 9/06

(52) U.S. Cl. CPC H04L 9/06; H04L 9/0643
USPC 713/164

(57) ABSTRACT

A configurable device and a method associated with the device is described, the device including. a cryptographic engine, a seed receiver operative to receive a seed, a part seed generator operative to receive a part number, and the seed from the seed receiver, and to generate a part seed based, at least in part, on the seed and the part number, a part generator operative to receive the part seed produced by the part seed generator to produce a crypto data item part based, at least in part, on the part seed, and a cryptosystem integrator operative to integrate the produced crypto data item part into the cryptographic engine, thereby producing a crypto product wherein the cryptographic engine uses the produced crypto product as an auxiliary input into a crypto graphic algorithm used to protect the digital content. Related methods, systems, and apparatus is also described.

### BACKGROUND OF THE INVENTION

A method for determining whether there exist linear estimations for look-up tables using the Walsh Transform is described at www.ciphersbyritter.com/ARTS/MEASNONL.HTM.

The following patents and patent applications are believed to reflect the state of the art:

U.S. Pat. No. 5,282,249 to Cohen, et al;

U.S. Pat. No. 5,481,609 to Cohen, et al; and

WO 02/06979 of NDS Ltd.

### SUMMARY OF THE INVENTION

The present invention, in certain embodiments thereof, seeks to provide an improved method and system for sending cryptographic data items to client devices.

There is thus provided in accordance with an embodiment of the present invention a configurable client device for consuming digital content, the device including a cryptographic engine, a seed receiver operative to receive a seed, a part seed generator operative to receive a part number, and the seed from the seed receiver, and to generate a part seed based, at least in part, on the seed and the part number, a part generator operative to receive the part seed produced by the part seed generator to produce a crypto data item part based, at least in part, on the part seed, and a crypto system integrator operative to integrate the produced crypto data item part into the cryptographic engine, thereby producing a crypto product wherein the cryptographic engine uses the produced crypto product as an auxiliary input into a cryptographic algorithm used to protect the digital content.

Further in accordance with an embodiment of the present invention the part number includes the counter value of a serial counter.

Still further in accordance with an embodiment of the present invention the part generator receives a crypto data item type, and the crypto data item part produced is based, at least in part, on both the part seed and the crypto data item type.

Additionally in accordance with an embodiment of the present invention and including the part seed generator receiving a configuration definition including a crypto data item type definition, and crypto data item generation parameters.

Moreover in accordance with an embodiment of the present invention the part seed generator generates the part seed as a result of a cryptographic hash function hashing the seed with the part number.

Further in accordance with an embodiment of the present invention the part generator includes a pseudo-random number generator (PRNG).

Still further in accordance with an embodiment of the present invention the PRNG receives the part seed as an input, and, based, at least in part on the input part seed, outputs an output.

Additionally in accordance with an embodiment of the present invention the PRNG output is utilized to build the crypto product.

Moreover in accordance with an embodiment of the present invention and including the cryptosystem integrator being further operative to receive the crypto product and to integrate the crypto product into an existing cryptosystem, thereby producing a new cryptosystem.

Further in accordance with an embodiment of the present invention the configuration definition includes an offset, and a crypto data item generator operative to produce the crypto product based, at least in part, on a portion of the part seed indicated by the offset.

Still further in accordance with an embodiment of the present invention the crypto product includes one of a look-up table, a matrix, and a permutation table.

There is also provided in accordance with another embodiment of the present invention a server including a seed generator operative to generate a seed, a part seed generator operative to receive a part number, and the seed from a seed receiver and to produce a part seed based, at least in part, on the seed and the part number, a part generator operative to receive the part seed produced by the part seed generator to produce a crypto data item part based, at least in part, on a bitstream, a tester operative to generate a crypto product from a plurality received crypto data item parts and to test the produced crypto product and verify that the produced crypto product has desired cryptographic properties, wherein the produced crypto product is used to implement a licensing regime over content consumed at a configurable device, and a transmitter operative, in response to a positive result of the verifying, to send the seed to the configurable device.

Further in accordance with an embodiment of the present invention the part number includes the counter value of a serial counter.

Still further in accordance with an embodiment of the present invention the part generator receives a crypto data item type, and the crypto data item part produced is based, at least in part, on both the part seed and the crypto data item type.

Additionally in accordance with an embodiment of the present invention and including the part seed generator receiving a configuration definition including a crypto data item type definition, and crypto data item generation parameters.

Moreover in accordance with an embodiment of the present invention the part seed generator generates the part seed as a result of a cryptographic hash function hashing the seed with the part number.

Further in accordance with an embodiment of the present invention the part generator includes a pseudo-random number generator (PRNG).

Still further in accordance with an embodiment of the present invention the PRNG receives the part seed as an input, and, based, at least in part on the input part seed, outputs an output.

Additionally in accordance with an embodiment of the present invention the PRNG output is utilized to build a crypto product.

Moreover in accordance with an embodiment of the present invention and including the tester is operative to test one of mathematical and cryptographic properties of the produced crypto product.

Further in accordance with an embodiment of the present invention and including a transmitter operative to transmit the seed at least in part as a result of positive testing of the tester.

Still further in accordance with an embodiment of the present invention the transmitter is operative to transmit the seed and the configuration definition at least in part as a result of positive testing of the tester.

Additionally in accordance with an embodiment of the present invention the crypto product includes one of a look-up table, a matrix, and a permutation table.

Moreover in accordance with an embodiment of the present invention the configurable device includes the configurable device described herein.

There is also provided in accordance with still another embodiment of the present invention a method including receiving a seed from a server, generating a part seed based, at least in part, on a part number, and the received seed, and generating a crypto data item part, based, at least in part, on the part seed, and integrating the generated crypto data item part into a cryptographic engine, thereby producing a crypto product wherein the cryptographic engine uses the generated crypto product as an auxiliary input into a cryptographic algorithm used to protect digital content.

Further in accordance with an embodiment of the present invention the method is performed at the configurable client device.

Still further in accordance with an embodiment of the present invention the server includes the server described herein.

There is also provided in accordance with yet another embodiment of the present invention a method including generating a seed, generating a part seed based, at least in part, on the seed and a part number, and generating a crypto data item part, based, at least in part, on the part seed, generating a crypto product from a plurality received crypto data item parts, and testing the generated crypto product and verifying that the generated crypto product has desired cryptographic properties, wherein the generated crypto product is used to implement a licensing regime over content consumed at a configurable device, and transmitting the seed to the configurable device in response to a positive result of the verifying.

There is also provided in accordance with yet another embodiment of the present invention a configurable device including a seed receiver operative to receive a seed, a part seed generator operative to receive a part number, and the seed from the seed receiver, and to generate a part seed based, at least in part, on the seed and the part number, and a part generator operative to receive the part seed produced by the part seed generator to produce a crypto data item based, at least in part, on the part seed.

There is also provided in accordance with another embodiment of the present invention a server including a seed generator operative to generate a seed, a part seed generator operative to receive a part number, and the seed from the seed receiver and to produce a part seed based, at least in part, on the seed and the part number, a part generator operative to receive the part seed produced by the part seed generator to produce a crypto data item based, at least in part, on the part stream.

There is also provided in accordance with still another embodiment of the present invention a configurable device including a seed receiver operative to receive a seed, a builder operative to receive the seed from the seed receiver and to produce a crypto product based, at least in part, on the seed.

There is also provided in accordance with yet another embodiment of the present invention a server including a seed receiver operative to receive a seed, a builder operative to receive the seed from the seed receiver and to produce a crypto product based, at least in part on the seed.

There is also provided in accordance with yet another embodiment of the present invention a method including receiving a seed, generating a part seed based, at least in part, on a part number, and the received seed, and generating a crypto data item, based, at least in part, on the part seed.

There is also provided in accordance with still another embodiment of the present invention a method including generating a seed, generating a part seed based, at least in part, on the seed and a part number, and generating a crypto data item, based, at least in part, on the part seed.

There is also provided in accordance with yet another embodiment of the present invention a method including receiving a seed at a seed receiver, receiving the seed from the seed receiver at a builder, producing, at the builder, a crypto product based, at least in part, on the seed.

### BRIEF DESCRIPTION OF THE DRAWINGS

The present invention will be understood and appreciated more fully from the following detailed description, taken in conjunction with the drawings in which:

FIG. 1 is a simplified block diagram illustration of a system for efficient delivery of structured data items constructed and operative in accordance with an embodiment of the present invention;

FIG. 2 is a simplified block diagram illustration of the tester-builder architecture of the system of FIG. 1;

FIG. 3 is a simplified block diagram illustration of the system of FIG. 1 in an embodiment where only one CDIP is produced; and

FIG. 4 is a simplified flowchart diagram of preferred methods of operation of the system of FIG. 1.

### DETAILED DESCRIPTION OF AN EMBODIMENT

In many DRM systems a family of cryptographic algorithms is used to protect the digital content. However, delivery of cryptographic algorithms and data items which are used by the cryptographic algorithms from the DRM server to a DRM client may entail significant network usage and require significant storage in the DRM client when these data items need to be used again. The need for significant network usage and significant storage requirements in the DRM client may be especially acute when dealing with dynamic cryptographic systems (i.e., “moving targets”), where the cryptographic algorithms are changed dynamically and from a distance, the transmission of various large tables to all devices is required. To complicate matters, at least some of these tables may be required to comply with cryptographic properties that may make them hard to compress using conventional data compression methods. To further complicate matters, different devices may need to receive different tables.

For example a DRM server may need to send eight client-specific matrices of 2048*2048 bits to each of one million clients, requiring network usage of approximately four terabytes.

The cryptographic data structures, e.g., matrices, are denoted in the present specification and claims as “crypto products”.

Crypto products can be sometimes divided into smaller data items which are denoted in the present specification and claims as “crypto data item parts” (CDIPs). This division is useful when the crypto product is used in the server or in the client one CDIP at a time. For example, matrices that are multiplied by a vector can be naturally divided into either rows or columns, depending on whether the multiplication is from the left or from the right.

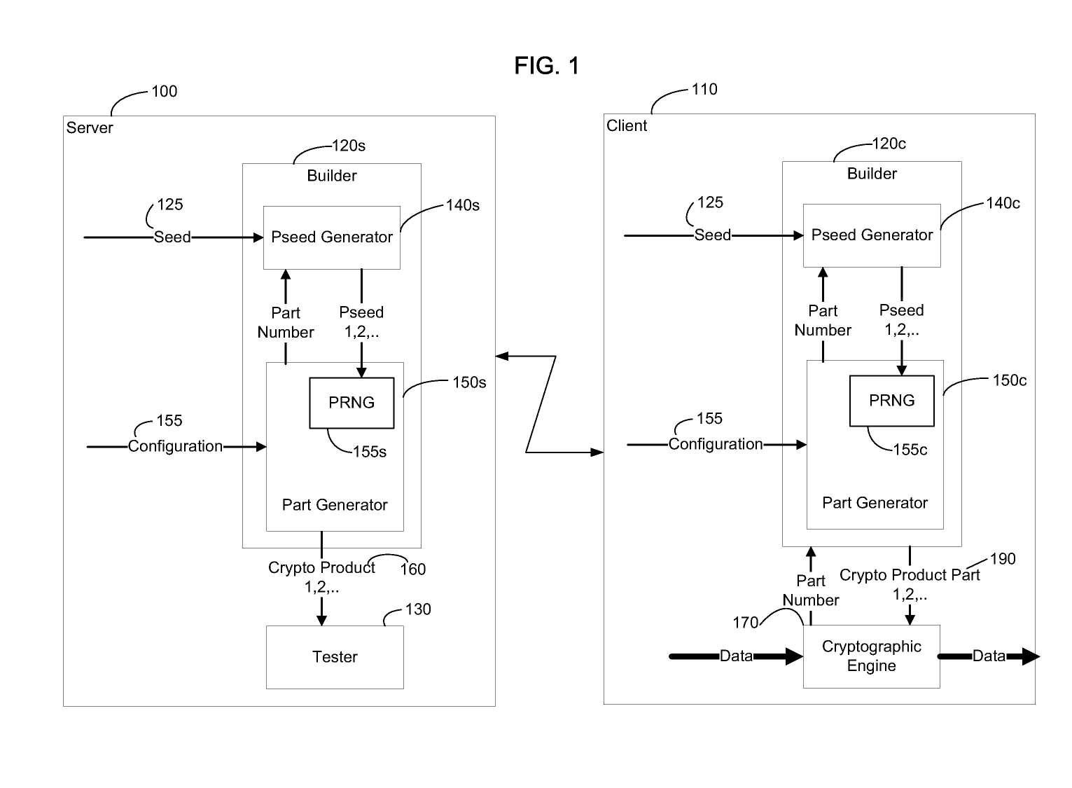

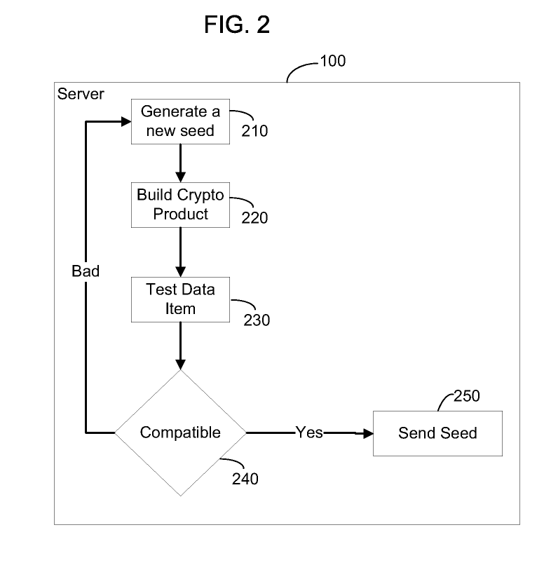

Reference is now made to FIG. 1, which is a simplified block diagram illustration of a system for efficient delivery of structured data items constructed and operative in accordance with an embodiment of the present invention. Reference is additionally made to FIGS. 2. FIG. 2 is a simplified block diagram illustration of the tester-builder architecture of the system of FIG. 1.

The system of FIG. 1 comprises a server 100 and a client 110. The server 100 comprises a server-side builder 120s and a tester 130. The client 110 comprises a client-side builder 120c.

The client 110 may be a consumer device, such as, but not limited to, a cell-phone, an e-reader, a music-playing or video-displaying device, or other appropriate device. In addition to the components of the client 110 discussed herein, the client 110 also comprises a processor (not depicted) and other appropriate hardware and software, as is known in the art.

The server 100 may be any one of a number of servers, including, but not limited to various multi-media servers, such as a streaming music server or an on-line book service or a cable television network. The server 100 typically implements some sort of a DRM or other licensing regime (such as a conditional access system) over content consumed at the client 110. For the purposes of the system of FIG. 1, the server 100 comprises computational resources which are significantly greater than those of the client 110.

The builder 120s, 120c comprise a Pseed (part seed) generator 140s, 140c and a part generator 150s, 150c. The pseed generator 140s, 140c receives a seed 125 from which a particular CDIP can be generated. The seed 125 comes from an application that uses the builder 120s, 120c, which, for the server side builder 120s, comprises the tester 130, and, for the client side builder 120c, comprises a cryptographic engine 170 (which is described below in greater detail). A typical Pseed generator 140s, 140c comprises a cryptographic hash function (one non-limiting example of which would be the well known SHA-256 hash function) which receives the seed and part number (a serial counter; for example, the first part is part number one, the second part is part number two, and so forth), hashes the received inputs, and outputs the Pseed. The output Pseed is input into the part generator 150s, 150c.

The part generator 150s, 150c operates to generate a CDIP from the input Pseed. The part generator 150s, 150c typically comprises a pseudo-random number generator (PRNG) 155s, 155c. PRNGs are well known in the art, and any appropriate PRNG, such as, but not limited to the well known RC4 PRNG that is the base of the RC4 stream cipher, The output of the PRNG is a large number of pseudo-random bits that is sufficient for generation of the CDIP, for example and without limiting the generality of the foregoing, 100 pseudo-random bits can be used to generate a row of a 100×100 matrix by simply filling the row with the bits. Since both the server-side pseed generator 150s and the client-side pseed generator 150c comprise the same PRNG 155s, 155c when the server-side pseed generator 150s and the client-side pseed generator 150c are inputted with an identical pseed, then both the server-side pseed generator 150s and the client-side pseed generator 150c will output the same output (i.e. the same pseed).

The part generator 150s, 150c, is operative to generate CDIPs (as noted above, crypto data item parts) of the crypto products as explained above. In addition, the part generator 150s, 150c may also receive a part number, such as a row number or a column number in the case of a matrix crypto product. In addition, the part generator 150s, 150c may also receive configuration data which comprises parameters for generation of the CDIPs, for example and without limiting the generality of the foregoing, a target portion of ones in the matrix-row or the matrix-column. From these inputs into the part generator 150s, 150c, a CDIP is generated. For example and without limiting the generality of the foregoing, a matrix-row or a matrix-column with a portion of ones that is within a specific range. Those skilled in the art will appreciate that different cryptographic schemes have different requirements for different data items, for example and without limiting the generality of the foregoing, a matrix, a number, a vector, a table of permutations, or a look-up table (herein denoted as crypto products). For instance, one cryptographic scheme may require a binary matrix populated with 40% ones and 60% zeros, and a second cryptographic scheme may require a binary matrix populated with exactly 50% zeros and 50% ones. Alternatively, a block cipher which employs a look-up table (s-box) typically requires that the look-up table have no linear estimations (i.e. no linear function should be similar to the look-up table). Such a requirement can be evaluated using the Walsh Transform, as explained at www.ciphersbyritter.com/ARTS/MEASNONL.HTM. Thus the part generator 150s, 150c comprises a mathematical function which takes the input pseudo-random numbers and outputs the zeros and ones in the desired proportion. Those skilled in the art will appreciate that there are many well known ways to generate crypto products such as matrices from a sufficient amount of pseudo-random bits in any desired proportion. The part generator 150s, 150c may also receive an input configuration 155 which, inter-alia dictates the proportion of zero and ones in the CDIP outputted by the part generator 150s, 150c. The input configuration 155 may also define which CDIP type is to be generated when the system is operative to generate different CDIPs for different crypto products.

The CDIP, depicted in FIG. 1 as Crypto Product 1,2, . . . 160 which is output by the server-side part generator 150s is input into the tester 130. The tester 130 aggregates the CDIP into a desired crypto product and then tests the crypto product. The tester 130 is programmed to verify that the crypto product under test has desired properties, for example good cryptographic properties. Those skilled in the art will appreciate that good cryptographic properties for linear items (e.g. matrices) comprise, inter-alia, a dependency of each of the output bits on a large portion of the input bits (the so-called avalanche property). That is to say, a matrix under test is said to have bad cryptographic properties if, when, during the test, an input is changed slightly (for example, flipping a single bit) the output does not change significantly (e.g., half the output bits flip). S-boxes (i.e. lookup tables) generated by the part generator 150s are said to have good cryptographic properties if the s-boxes are compliant with the avalanche property and the transformations represented by the s-boxes are properly distant from linear transformations. The discussion above of testing s-boxes using the Walsh Transform is relevant as well for determining the cryptographic properties of the s-boxes. P-boxes generated by the part generator 150s are said to have good cryptographic properties if the p-boxes result in cryptographically acceptable levels of spreading of bits.

Tests and test modules for various cryptographic modules (e.g. matrices, s-boxes and p-boxes) are well known to those skilled in the art, and are implementable utilizing the computation power available at the server, as discussed above.

In case the crypto product does not comply with the desired properties, the builder can be inputted with a new input seed 125, and if the resultant crypto product also does not comply with the desired properties, a third seed 125 can be generated and so on until a proper crypto product that has the desired properties and passes the required tests is found, as is described below with reference to FIG. 2.

Once a crypto product is found which passes the tests of the tester 130, the seed 125 that was used to generate can then be transmitted to the client 110 as a compressed version of the crypto product, allowing the recovery of the crypto product in the client side builder. The transmission of the seed 125 can be performed using encrypted and/or authenticable communications.

Referring specifically to FIG. 2, the flow of data in the server is as follows. A new seed 125 is generated 210. The seed 125 may be a produced by a counter, and comprise a next, sequential number taken from the counter. Alternatively, the seed 125 may be taken from the least significant bits of the time on a server clock. Alternatively, the seed 125 may be generated by a true RNG or pseudo RNG.

The seed 125 generated in step 210 is utilized, as described with reference to FIG. 1, to generate/build the desired crypto product 160 (step 220). The built/generated crypto product 160 is input to the tester 130 for testing 230. The tester 130 tests to determine if the built crypto product 160 is compatible for use in the client 240, as described above. If the crypto product 160 is determined to be compatible for use in the client in step 240, then the seed 125 is sent to the client 110 (step 250). The client device 110, receives the seed. However, if the crypto product 160 is determined to not be compatible for use in the client in step 240, then a new seed 125 is generated again, and the system returns to step 210.

Returning now to the description of FIG. 1, the client device 110 comprises a builder 120c which is, by design, identical to the builder comprised at the server 100. Thus, when the client-side builder 120c and the server side builder 120s are input an identical part seed, both the client-side builder 120c and the server side builder 120s will output a crypto product part 190 corresponding to the CDIP 160 for the each different part number and consequently will generate the same crypto product. The client-side part generator 150c also receives an identical input configuration 155 to that received by the server-side part generator 150s. The crypto product part 190 is integrated, by a cryptosystem integrator (not depicted), into a cryptographic engine 170, either at once as the entire crypto product or one CDIP at a time. The cryptographic engine 170 comprises a cryptographic algorithm that needs the crypto product as its auxiliary input. For example and without limiting the generality of the foregoing, most of the block ciphers (e.g., AES, DES) need s-box crypto products as part of their processing.

In addition, if it is determined as a result of the testing that a data item is suitable for use in the client 110 beginning after a certain number of bits resulting from the seed 125 (that is to say, an offset), then the offset can also be sent, along with the seed 125 from the server 100 to the client 110. The client 110 can then build the data item by generating the certain number of bits (i.e. the offset), and not storing those bits. Afterwards, the next bits are used to populate the desired data item.

It is additionally appreciated that if a certain row or column of a matrix is determined to have the desired properties for the data item, then the row number or column number can be sent from the server 100 to the client 110 as the offset.

It is appreciated that the description of the builder 120s, 120c hereinabove is one of many possible designs and embodiments. Alternatively the builder might comprise a bitstream generator (such as a PRNG) which outputs a bitstream into a part generator. The part generator would generate zeros and ones as needed in order to build the desired crypto product or data item.

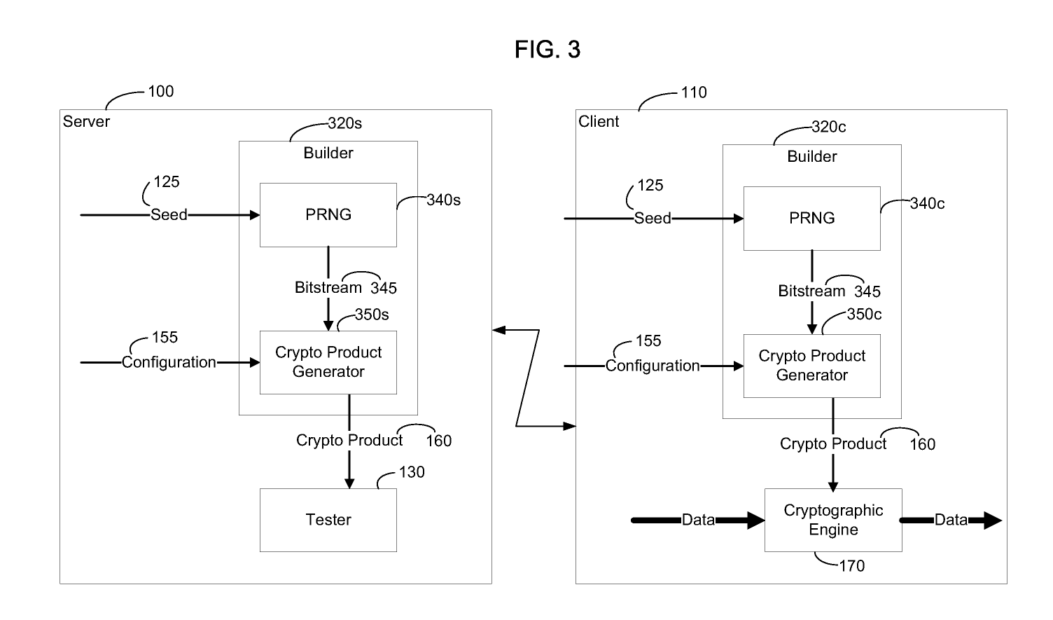

Reference is now made to FIG. 3 is a simplified block diagram illustration of the system of FIG. 1 in an embodiment where only a single CDIP is produced. The case where only one CDIP is produced is a special case, dealt with herein below. The server-side builder 320s receives the seed 125, as noted above. The seed 125 is input directly into a server-side PRNG 340s. The server-side PRNG 340s outputs, according to the seed 125, a bitstream 345, which is input into a server-side crypto product generator 350s. The crypto product generator 350s operates as does the part generator 150s described above. The crypto product 160 generated by the crypto product generator 350s is input into the tester 130. When a crypto product 160 is generator which is deemed acceptable by the tester 130, then, as above, the seed 125 and the configuration 155 are transmitted to the client 110.

At the client device, the seed 125 is input to a client side PRNG 340c. The client side PRNG 340c outputs, according to the seed 125, a bitstream 345, which is input into a client-side crypto product generator 350c. The crypto product generator 350c operates as does the part generator 150c described above. The crypto product 160 generated by the crypto product generator 350c is input into the cryptographic engine 170. The crypto product is integrated, by a cryptosystem integrator (not depicted), into the cryptographic engine 170.

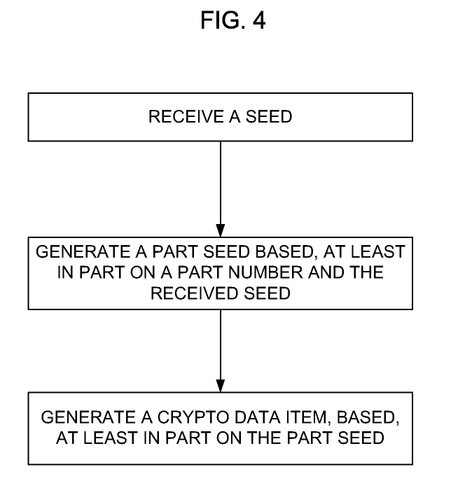

Reference is now made to FIG. 4, which is a simplified flowchart diagram of preferred methods of operation of the system of FIG. 1. The method of FIG. 4 is believed to be self explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product; on a tangible medium; or as a signal interpretable by an appropriate computer.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A configurable client device for consuming digital content, said device comprising:
a cryptographic engine;
a seed receiver operative to receive a seed;
a part seed generator operative to receive:
a part number; and
the seed from the seed receiver, and to generate a part seed based, at least in part, on the seed and the part number;
a part generator operative to receive the part seed produced by the part seed generator to produce a crypto data item part based, at least in part, on the part seed; and
a cryptosystem integrator operative to integrate the produced crypto data item part into the cryptographic engine, thereby producing a crypto product
wherein the cryptographic engine uses the produced crypto product as an auxiliary input into a cryptographic algorithm used to protect said digital content.

2. The device according to claim 1 and wherein the part number comprises the counter value of a serial counter.

3. The device according to claim 1 and wherein the part generator receives a crypto data item type, and the crypto data item part produced is based, at least in part, on both the part seed and the crypto data item type.

4. The device according to claim 1 and further comprising the part seed generator receiving a configuration definition comprising:
a crypto data item type definition; and
crypto data item generation parameters.

5. The device according to claim 1 and wherein the part seed generator generates the part seed as a result of a cryptographic hash function hashing the seed with the part number.

6. The device according to claim 1 and wherein the part generator comprises a pseudo-random number generator (PRNG).

7. The device according to claim 6 and wherein the PRNG receives the part seed as an input, and, based, at least in part on the input part seed, outputs an output.

8. The device according to claim 6 and wherein the PRNG output is utilized to build the crypto product.

9. The device according to claim 1 and also comprising:
the cryptosystem integrator being further operative to receive the crypto product and to integrate the crypto product into an existing cryptosystem, thereby producing a new cryptosystem.

10. The device according to claim 4 and wherein the configuration definition includes an offset, and a crypto data item generator operative to produce the crypto product based, at least in part, on a portion of the part seed indicated by the offset.

11. The device according to claim 1 and wherein the crypto product comprises one of a look-up table; a matrix; and a permutation table.

12. A server comprising:
a seed generator operative to generate a seed;
a part seed generator operative to receive:
a part number; and
the seed from a seed receiver and to produce a part seed based, at least in part, on the seed and the part number;
a part generator operative to receive the part seed produced by the part seed generator to produce a crypto data item part based, at least in part, on a bitstream;
a tester operative to generate a crypto product from a plurality received crypto data item parts and to test the produced crypto product and verify that the produced crypto product has desired cryptographic properties, wherein the produced crypto product is used to implement a licensing regime over content consumed at a configurable device; and
a transmitter operative, in response to a positive result of the verifying, to send the seed to the configurable device.

13. The server according to claim 12 and wherein the part number comprises the counter value of a serial counter.

14. The server according to claim 12 and wherein the part generator receives a crypto data item type, and the crypto data item part produced is based, at least in part, on both the part seed and the crypto data item type.

15. The server according to claim 12 and further comprising the part seed generator receiving a configuration definition comprising:
a crypto data item type definition; and
crypto data item generation parameters.

16. The server according to claim 12 and wherein the part seed generator generates the part seed as a result of a cryptographic hash function hashing the seed with the part number.

17. The server according to claim 12 and wherein the part generator comprises a pseudo-random number generator (PRNG).

18. The server according to claim 17 and wherein the PRNG receives the part seed as an input, and, based, at least in part on the input part seed, outputs an output.

19. The server according to claim 17 and wherein the PRNG output is utilized to build a crypto product.

20. The server according to claim 12 and also comprising:
a tester operative to test one of: mathematical and cryptographic properties of the produced crypto product.

21. The server according to claim 12 and also comprising:
a transmitter operative to transmit the seed at least in part as a result of positive testing of the tester.

22. The server according to any of claims 21 and wherein the transmitter is operative to transmit the seed and the configuration definition at least in part as a result of positive testing of the tester.

23. The server according to claim 12 and wherein the crypto product comprises one of a look-up table; a matrix; and a permutation table.

24. The server according to claim 12 and wherein the configurable device comprises the configurable device according to claim 1.

25. A method comprising:
receiving a seed from a server;
generating a part seed based, at least in part, on:
a part number; and
the received seed; and
generating a crypto data item part, based, at least in part, on the part seed; and
integrating the generated crypto data item part into a cryptographic engine, thereby producing a crypto product
wherein the cryptographic engine uses the generated crypto product as an auxiliary input into a cryptographic algorithm used to protect digital content.

26. The method according to claim 25, and wherein the method is performed at the configurable client device of claim 1.

27. The method according to claim 25 and wherein the server comprises:
a seed generator operative to generate a seed;
a part seed generator operative to receive:
a part number; and
the seed from a seed receiver and to produce a part seed based, at least in part, on the seed and the part number;
a part generator operative to receive the part seed produced by the part seed generator to produce a crypto data item part based at least in part, on a bitstream;
a tester operative to generate a crypto product from a plurality received crypto data item parts and to test the produced crypto product and verify that the produced crypto product has desired cryptographic properties, wherein the produced crypto product is used to implement a licensing regime over content consumed at a configurable device; and
a transmitter operative, in response to a positive result of the verifying, to send the seed to the configurable device.

28. A method comprising:
generating a seed;
generating a part seed based; at least in part, on the seed and a part number; and
generating a crypto data item part, based, at least in part, on the part seed;
generating a crypto product from a plurality received crypto data item parts; and
testing the generated crypto product and verifying that the generated crypto product has desired cryptographic properties, wherein the generated crypto product is used to implement a licensing regime over content consumed at a configurable device; and
transmitting the seed to the configurable device in response to a positive result of the verifying.

29. The method according to claim 28 and wherein the configurable device comprises:
a cryptographic engine;
a seed receiver operative to receive a seed;
a part seed generator operative to receive:
a part number; and
the seed from the seed receiver, and to generate a part seed based, at least in part, on the seed and the part number;
a part generator operative to receive the part seed produced by the part seed generator to produce a crypto data item part based, at least in part, on the part seed; and
a cryptosystem integrator operative to integrate the produced crypto data item part into the cryptographic engine, thereby producing a crypto product
wherein the cryptographic engine uses the produced crypto product as an auxiliary input into a cryptographic algorithm used to protect said digital content.

30. A configurable client device for consuming digital content, said device comprising:
means for receiving a seed from a server;
means for generating a part seed based, at least in part, on:
a part number; and
the received seed; and
means for generating a crypto data item part, based, at least in part, on the part seed; and
means for integrating the generated crypto data item part into a cryptographic engine, thereby producing a crypto product
wherein the cryptographic engine uses the generated crypto product as an auxiliary input into a cryptographic algorithm used to protect digital content.

31. A server comprising:
means for generating a seed;
means for generating a part seed based, at least in part, on the seed and a part number; and
means for generating a crypto data item part, based, at least in part, on the part seed;
means for generating a crypto product from a plurality received crypto data item parts; and
means for testing the generated crypto product and verifying that the generated crypto product has desired cryptographic properties, wherein the generated crypto product is used to implement a licensing regime over content consumed at a configurable device; and
means for transmitting the seed to the configurable device in response to a positive result of the verifying.
